(19) United States
(12) Patent Application Publication
(10) Pub. No.: US 2004/0010065 A1
(43) Pub. Date: Jan. 15, 2004

(54) Discoloration inhibitor for metals

(76) Inventors: Noriyuki Kohara, Kurashiki-shi (JP); Hideyuki Tsurumi, Okayama-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/617,393

(22) Filed: Jul. 11, 2003

(30) Foreign Application Priority Data
Jul. 12, 2002 (JP) 2002-203792

(51) Int. Cl. C08K 3/00; C08K 3/08; C08K 3/22; C08K 3/18; C23F 11/00; C08L 1/00; C08J 3/00; C08K 3/32; C08K 3/10

(52) U.S. Cl. 524/401; 524/403; 524/413; 524/414; 524/417; 524/430; 524/431; 524/434; 524/435; 524/439; 524/440; 422/8

(57) ABSTRACT

An object of the present invention is to provide a discoloration inhibitor for metals, for protecting metal artifacts, such as those made of silver, copper, and nickel, or their alloys, from discoloration due to sulfur-containing gases such as sulfur oxide (SOx), mercaptans, and hydrogen sulfide, for example, during display or storage of the metal artifacts. A discoloration inhibitor for metals comprising: a fiber having a crosslinking structure and containing carboxyl groups therein, at least part of said carboxyl groups being present as a salt of an alkali metal, an alkali earth metal or ammonia; and fine particles of a metal and/or a metal compound substantially insoluble in water and reactive with a sulfur-containing compound dispersed in said fiber is disclosed.

### BACKGROUND OF THE INVENTION

1. Field of the Invention

The present invention relates to a discoloration inhibitor, and in particular to a discoloration inhibitor that, during storage and display of a variety of artifacts made of metals such as silver, copper, nickel, and chromium or their alloys, protects the metal artifacts as much as possible from discoloration due to sulfur-containing gases such as sulfur oxides (SOx's), mercaptans, and hydrogen sulfide.

1. Description of the Prior Art

Metal artifacts made of silver, copper, nickel, chromium, or the like: for example, decorative accessories such as necklaces, pendants, rings, cuffs, and scarf pins; musical instruments such as flutes, saxophones, and trumpets; tableware such as shakers, cups, forks, spoons, knifes, and other tabletop accessories; and room decorations such as flower vases, various figurines and bibelots; generally have sufficiently high corrosion resistance, for example to oxidation, but do not have durability as high as that of the artifacts made of gold or platinum. It is known that these artifacts can be attacked especially by oxygen in air and sulfur-containing compounds that are present in a minute amount in air or in environment (e.g., gases such as SOx, sulfurous acid gas, mercaptans, and hydrogen sulfide), resulting in staining and discoloration, for example to black or green, of the surface thereof.

For prevention of the staining and discoloration, methods to store these metal artifacts together with a dehumidification agent or an oxygen absorbent in a tightly sealed gas-barrier container were proposed (e.g., Japanese Unexamined Patent Publication 8-38883, and ibid. 9-272568).

However, although it is sufficiently possible by these methods to protect metal artifacts from discoloration during storage or transportation under a rigorous control for preventing rust, it is practically impossible to do such a rigorous rust proofing as described above when the artifacts, after being removed from the sealed container, are displayed in a showcase or the like or when they are purchased and brought home by a consumer and stored in a jewelry box, cabinet, or the like; in most cases, these artifacts are displayed or stored as they are exposed under an air atmosphere. Therefore, the metal artifacts, when exposed to an air environment, are prone to oxidation, especially under a humid condition, or may be attacked by sulfur-containing compounds present in a minute amount in air, resulting in staining and discoloration thereof.

As the method for prevention of these problems, Japanese Unexamined Patent Publication 8-224434, for example, described a method for prevention of the staining and discoloration, in which the artifacts are placed in a show window or a show case for displaying the above metal artifacts together with a compound fiber material produced by mix spinning of a wool fiber containing thiol-copper complexes in its cell membrane complexes and a water absorbing fiber, which functions in the presence of water as an absorbent for hazardous gases such as the sulfur-containing compounds.

By these methods, however, it is necessary to place the compound fiber material in an environment containing a suitable amount of water in order to make the most of the absorption potential of the thiol-copper complexes for removal of the sulfur-containing compounds, and therefore to keep the interior of the show window or showcase under a humid condition, raising a problem that the oxidative degradation of the metal artifacts is rather accelerated under the humid environment. Accordingly, these methods do not always provide results satisfactory for the prevention of discoloration.

Alternatively, the present inventors have been engaged in a research for functional fibers and proposed as part of the research the process disclosed in Japanese Unexamined Patent Publication 9-241967. The invention relates to a fiber having a crosslinking structure and containing polar groups that allow ion exchange or coordination and fine particles of a metal or metal salt substantially insoluble in water dispersed therein, which has excellent properties as a new type of deodorant fiber as it has a high deodorizing potential to eliminate hydrogen sulfide, ammonia, and the like. Amid a recent change in life style and a trend toward mote air-tight living space, the fiber was, however, developed primarily for the purpose of preserving a pleasant living environment, focusing only on its deodorizing potential and without any regard to the potential for the “protection of metal artifacts from discoloration.”

The present invention has been completed to solve such problems, an object of the present invention is to provide a discoloration inhibitor that does not require an active addition of water as was described in Japanese Unexamined Patent Publication 8-224434 and yet retains its excellent capability as a discoloration inhibitor for metal artifacts for an extended period of time.

### SUMMARY OF THE INVENTION

A discoloration inhibitor for metals according to the present invention that solved the above problems is characterized in that the discoloration inhibitor comprises: a fiber having a crosslinking structure and containing carboxyl groups bound thereto, at least part of said carboxyl groups being present as a salt of an alkali metal, an alkali earth metal or ammonia; and fine particles of a metal and/or a metal compound substantially insoluble in water and reactive with a sulfur-containing compound dispersed in said fiber.

### DETAILED DESCRIPTION OF THE INVENTION

A discoloration inhibitor for metals according to the present invention is characterized in that the discoloration inhibitor comprises: a fiber having a crosslinking structure and containing carboxyl groups therein, at least part of said carboxyl group being present as a salt of an alkali metal, an alkali earth metal or ammonia; and fine particles of a metal and/or a metal compound substantially insoluble in water and reactive with sulfur-containing compounds dispersed in said fiber.

The mechanism for the prevention of discoloration of metals such as silver by the discoloration inhibitor has not been clearly understood currently, but it is likely that the metal and/or metal compound finely dispersed in the crosslinked fibers, along with the carboxylate groups contained in the fiber having a moisture absorption and retention capability, traps sulfur-containing compounds such as SOx, hydrogen sulfide, and mercaptans present in environment and inhibits the staining and discoloration of metals due to these sulfur-containing compounds.

The fiber that constitutes the basic skeleton of the discoloration inhibitor of the present invention is not particularly limited, and any kind of fibers may be used if they have a crosslinking structure and contain carboxyl groups in the fiber molecules, but in view of productivity, strength of the skeleton fiber, mass production, cost, and the like, the most preferable is an acrylic fiber crosslinked by any conventional method, in particular a crosslinked acrylic fiber containing carboxyl groups that are introduced by partial hydrolysis of an acrylonitrile or acrylic ester fiber.

The purpose of introducing the crosslinking structure into the fiber is to provide it with an adequate strength and an insolubility in water even when the fiber incorporates hydrophilic carboxyl groups by hydrolysis and also with a property resistant to the possible physical and chemical deterioration that may occurs during a reaction to form fine particles of a substantially insoluble metal and/or metal compound by the method that will be described below. Examples of the crosslinking structure include those by covalent bonding, ionic bonding, and chelate bonding. The method for introducing the crosslinking structure is also not particularly limited, but as the discoloration inhibitor should be prepared in the form of fiber, the crosslinking is preferably introduced after the fiber has previously been produced by the spinning and drawing processes according to the common processes.

The acrylonitrile-based crosslinked fiber that is produced by crosslinking of an acrylonitrile polymer with hydrazine or the like is recommended as a fiber of practical use, as it not only has an excellent mechanical property of fiber, but also a greater capacity to hold the fine particles of substantially insoluble metal and/or metal compound when prepared by the method that will be described below and an excellent heat stability and as it can be produced at a more economical cost.

The fiber having a crosslinking structure should have at least part of the carboxyl groups therein being present as a salt of an alkali metal, an alkali earth metal, ammonia or the like to have an adequate moisture absorption and retention capacity. And the fiber having the carboxyl groups present as an alkali metal salt, such as a sodium or potassium salt, is preferable, as it provides itself with a greater moisture absorption and retention capacity even when the extent of conversion to the metal salt is limited.

With respect to acrylonitrile and acrylic ester-based fibers, carboxyl groups are generally introduced to the fiber that has already been processed and crosslinked by hydrolysis of the nitrile and ester groups therein. The amount of carboxyl groups to be introduced may be arbitrarily determined according to the amount of desirable moisture absorption and retention capacity of the resulting fiber taking account of the amount of the salt introduced such as an alkali metal salt that will be described below. The amount thereof is preferably in a range of 1 to 10 millimole as carboxyl group with respect to 1 g of the fiber, more preferably of 3 to 10 millimole; and 60 mole % or more, more preferably 80 mole % or more of the carboxyl group are preferably neutralized with the alkali metal or the like for increasing the discoloration inhibiting effect.

Suitable examples of the metal and/or metal compound to be held by the fiber having carboxyl groups includes any kind of metals or metal compounds that are reactive with sulfur-containing compounds and substantially insoluble in water. Substantially insoluble in water herein means the metal and/or metal compound which do not substantially effuse from the fiber when dipped in water under working condition (at room temperature under atmospheric pressure). For increasing the discoloration inhibiting effect, metals such as silver, copper, zinc, manganese, iron, nickel, aluminum, tin, molybdenum, and magnesium; or oxides, hydroxides, chlorides, bromides, iodides, carbonates, sulfates, phosphates, chlorates, bromates, iodates, sulfites, thiosulfates, thiocyanates, pyrophosphates, polyphosphates, silicates, aluminates, tungstates, vanadates, molybdates, antimonates, benzoates, and dicarboxylates thereof are exemplified as the preferable metal and/or metal compound. These compounds (metal and/or metal compound) may be used alone or in combination of two or more compounds if desired.

The diameter of the fine particles of these metal and/or metal compounds (hereinafter maybe called as metal base fine particles) is not particularly limited, but preferably as small as possible in order to provide the particles with a greater surface area, and thus a greater capacity for trapping sulfur compounds and a discoloration inhibitory action, and most preferably at a submicron order, i.e., 1 μm or below.

With respect to the structure of the fiber containing the fine particles of these metal and/or metal compounds, the fiber is preferably a porous fiber, particularly a porous fiber having pores with a diameter of about 1 μm or less that are interconnected to each other and extend to the surface of fiber, from a viewpoint of increasing the surface area per unit weight as much as possible, making the most of the potential of metal and/or metal compounds contained in the fiber, and thus increasing the capacity of the fiber for trapping sulfur compounds and inhibiting discoloration of metals.

As described above, the discoloration inhibitor of the present invention is a fibrous material comprising a fiber having a crosslinking structure and containing fine particles of a metal and/or metal compound substantially insoluble in water dispersed therein, and suitable processes for manufacturing the same include (1) a process of spinning a mixture of a polymer constituting the fiber and particles of a metal and/or metal compound into a fiber, (2) a process of bonding fine particles of a metal and/or metal compound onto the surface of a fiber by means of a binder, and (3) a process of depositing in a fiber fine particles of a metal and/or metal compound that are generated by first binding a metal to carboxyl groups contained in the fiber molecules and subsequently breaking the metal away from the carboxyl groups in a chemical reaction.

As process (3) is most preferable among the processes described above, hereinafter a process of depositing a silver (or copper) compound in a crosslinked acrylic fiber according to this process will be described more specifically.

Crosslinked acrylic fibers can be produced according to any method known and routinely practiced in the art. For example, a crosslinked acrylic fiber may be produced by crosslinking of an acrylic fiber with a hydrazine-based compound or the like. As the fiber becomes substantially insoluble in water or other common solvents by the crosslinking treatment, processing into fiber, for example spinning, should be conducted before the crosslinking treatment.

Subsequently, hydrolysis of the crosslinked acrylic fiber with an acid or alkali, i.e., hydrolysis of nitrile or ester groups in the crosslinked acrylic fiber molecules, gives an acrylic fiber having free carboxylic acid groups in the case of acid treatment, or that having alkali metal carboxylate groups in the case of alkali treatment. As the hydrolysis progresses, the amount of the carboxyl groups formed increases. It is desirable to control the reaction to such an extent that the amount of carboxyl groups formed falls in a range of about 1 to 10 mmol/g, preferably of about 3 to 10 mmol/g, more preferably of about 3 to 8 mmol/g, in order to efficiently increase the amount of silver or copper or the compounds thereof to be contained in the fiber in the next process. The presence of carboxyl groups in an amount of about 1 mmol/g or more improves content of the silver (or copper) compound in the fiber which results in obtaining higher discoloration inhibiting effect. While excessive carboxylation of the fiber to an amount of more than 10 mmol/g maintains its discoloration inhibiting effect, the property of the fiber may be lowered.

Treatment of the crosslinked acrylic fiber having carboxyl groups or the metal salt thereof with an aqueous solution containing silver (or copper) ions provides a fiber having silver (or copper) ions bonded to carboxyl groups in the fiber molecules.

Reduction of the above fiber having silver (or copper) ions bonded to the carboxyl groups thereof gives a crosslinked acrylic fiber having silver (or copper) metal particles (i.e., discoloration inhibitor). Alternatively, treatment of the same fiber with an aqueous solution containing a compound that precipitates a substantially insoluble compound in reaction with silver (or copper) ions gives a crosslinked acrylic fiber having fine particles of a silver (or copper) compound.

The reduction methods above are not particularly limited so long as a metal ion is reduced to a metal thereby, and for example, compounds which provide electron to metal ion and more specifically may include: a reduction method in an aqueous solution using a reducing agent such as sodium borohydride, hydrazine, formaldehyde, compounds having an aldehyde group, hydrazine sulfate, hydrocyanic acid and its salts, hyposulfurous acid and its salts, thiosulfuric acid, hydrogen peroxide, Rochelle salt, or hypophosphorous acid and its salts; a method by heat-treatment under an atmosphere of a reducing agent such as hydrogen or carbon monoxide; a method by photoirradiation; and methods in combination of the methods above.

During the reduction reaction in an aqueous solution, the reaction mixture may additionally contain, if desired: pH adjusters including basic compounds such as sodium hydroxide and ammonium hydroxide, and inorganic and organic acids; buffer agents including oxycarboxylic acid compounds such as sodium citrate, inorganic acids such as boric acid and carbonic acid, and alkali salts of organic and inorganic acids; accelerators such as fluorides; stabilizers such as salts of chloride, bromide, and nitrate; and surface-active agents.

The compound that forms a substantially insoluble compound as a precipitate in a reaction with silver ion (or copper ion) is also not particularly limited and may be any compound so long as it has a potential to trap sulfur compounds in reaction with the same. Suitable examples of the compound include oxides, hydroxides, chlorides, bromides, iodides, carbonates, sulfates, phosphates, chlorates, bromates, iodates, sulfites, thiosulfates, thiocyanates, pyrophosphates, polyphosphates, silicates, aluminates, tungstates, vanadates, molybdates, antimonates, benzoates, and dicarboxylates.

The metal ions bound to carboxyl groups in the fiber molecules leave the same in the reduction reaction above and silver (or copper) or the compound thereof formed in the above reduction reaction deposits as a fine insoluble matter in the vicinity of the fiber molecules. Consequently, after washing and drying thereof, a fiber having extremely fine particles of the metal or metal compound deposited inside and on the surface of the crosslinked fiber molecules can be obtained. Accordingly, silver (or copper) or the compound thereof deposited on and in the crosslinked fibers is present in the fibers as very minute particles having an extremely large surface area (i.e., interfacial surface for the reaction with sulfur-containing compounds); and when the crosslinked fibers are exposed to an environment containing sulfur compounds, silver (or copper) or the compound thereof in the form of fine particle rapidly reacts with and traps the sulfur compounds.

As far as the present inventors confirmed, the potential of the above metal and/or metal compound for trapping sulfur-containing compounds can be effectively brought out only in the presence of the moisture absorbing and retaining functional groups such as alkali metal carboxylate groups, and the inhibitory effect on discoloration of metals at a level desirable in the present invention cannot be achieved in the absence of the alkali salt groups or the like. The causal relationship has not been clear understood, but the sulfur-containing compounds are likely to be absorbed by the fiber due to the moisture absorbing and retaining effect derived from the presence of alkali salt groups or the like, and firmly trapped by a reaction with the metal and/or metal compound.

At any rate, when the crosslinked fiber containing the carboxylate salt groups for moisture absorption and retention and the metal and/or metal compound is placed in a showcase or display container displaying metal artifacts such as silver articles or in a storage container storing the same, sulfur compounds in the environment are rapidly trapped and removed, enabling protection of the artifacts from phenomena of staining and discoloration as much as possible.

The discoloration inhibitor for metals of the present invention having the features described above may have a variety of forms in appearance and shape, including spun yarn, yarn (including lap yarn), filament, nonwoven fabric, woven fabric, knitted fabric, sheet, matt, wad of staple fiber, and laminate. In addition, the crosslinked fiber having the discoloration inhibitory function may be used alone, or may of course be blended with other natural, synthetic, semisynthetic fibers (e.g., as a blended yarn or a combined filament yarn). However, even when the fiber is used as blended with other fibers, the content of the metal or metal compound substantially insoluble in water is desirably 0.1 mass % or more with respect to the total mass of the discoloration inhibitor for obtaining better discoloration inhibiting effect.

It is extremely effective in bringing this invention into practical use to provide a discoloration inhibitor processed into a two-layered laminated structure, consisting of a nonwoven sheet or matt with an appropriate thickness prepared from the discoloration inhibitory material containing the crosslinked fiber and a double-faced tape bonded to one side thereof, so that the discoloration inhibitor may be easily adhered to any place in the space where metal artifacts are displayed or stored.

### EXAMPLE

Hereinafter, the present invention will be described more specifically with reference to an EXAMPLE, but it should be understood that the following EXAMPLE is not intended to limit the scope of the present invention, and any modifications within the range of features described above or below are also included in the technical scope of the present invention. Methods used for evaluation in the EXAMPLE are as follows:

Absorption of sulfurous gases

A sample of discoloration inhibitor was cut into pieces with a width of 5 cm and a length of 5 cm, which were conditioned under an environment of 20° C. and 65% RH for 24 hours or more. Silver and copper foils were used as reference samples. These foils were cut respectively into pieces with a width of 2 cm, a length of 2 cm and a thickness of 0.20 mm, which were treated in a dryer at 105° C. for 1 hour or more to remove moisture attached thereto. “Ag-403384” of Nilaco Corp. was used as the silver foil, while “Cu-113381” of Nilaco Corp., as the copper foil.

Subsequently, the discoloration inhibitor and the reference samples and a discoloring gas containing H₂S or SO₂ at a concentration of 3 ppm that was previously adjusted to a condition of 20° C. and 65% RH were placed and sealed in a Tedlar bag (volume: 2 liter), which was left under an environment of 20° C. and 65% RH. After 24 hours, the discoloration inhibitor and reference pieces were removed swiftly from the bag and transferred and sealed in a polyethylene container. The discolouring gas was prepared by diluting H₂S or SO₂ gas with air.

The amount of sulfur absorbed by the reference sample The amount of sulfur absorbed by the reference sample was determined by a photoelectron spectroscopic ESCA apparatus (Ulvac-phi inc., “PHI5800”), employing Mg—Kα line as an X-ray source at 200 W for the silver reference sample or employing Al—Kα line at 200 W for the copper reference sample. The analysis was conducted in the condition of: a pass energy of 29.35 eV and a resolution of 0.125 eV/step; the intensity of [C]1s, [O] 1s, [S]2p, and [Ag]3d or [Cu] 2p spectra was determined; and the ratio (%) of each atom with respect to the sum of C+O+S+Ag or C+O+S+Cu as 100% was calculated. In addition, the ratio of S/Ag or S/Cu was calculated by dividing the S atom ratio (%) by the Ag atom ratio (%) when the reference sample was Ag or the Cu atom ratio (%) when the reference sample was Cu. Here, charge transfer satellite peaks deriving from CuO were also included for calculation of the Cu atom ratio.

The reference sample preferably has a smaller S atom ratio (%) and a smaller S/Ag or S/Cu value in this measurement, which indicates that the discoloration inhibitor of the present invention is effective as a discoloration inhibitor for protecting the reference sample.

### EXAMPLE 1

10 Mass parts of an acrylonitrile-based polymer consisting of 90 mass % of acrylonitrile and 10 mass % of vinyl acetate (intrinsic viscosity [η]: 1.2 in dimethylformamide at 30° C.) was dissolved in 90 mass parts of an aqueous solution containing 48 mass % of sodium rhodanate to give a spinning dope. After spinning from the spinning dope and drawing (total draw ratio: 10 times) according to the common method, the resulting filament was dried and heat-moisture treated under an atmosphere at dry-bulb and wet-bulb temperatures respectively of 120° C. and 60° C., and cut into staple fiber with a filament fineness of 0.9 dtex and a length of 38 mm.

The staple fiber was crosslinked in an aqueous solution containing 20 mass % of hydrazine hydrate at 98° C. for 5 hours, and then washed. Subsequently, the fiber was treated in an aqueous solution containing 3 mass % nitric acid at 90° C. for 2 hours, hydrolyzed in an aqueous solution containing 3 mass % of sodium hydroxide at 90° C. for 2 hours, and washed with purified water. A fiber containing 5.5 mmol/g of sodium carboxylate groups was obtained by this treatment. The fiber thus obtained was then treated in an acid (an 5% aqueous solution of nitric acid at 60° C. for 0.5 hour), washed with water, dipped in an oiling bath, dehydrated, and dried in that order, giving a crosslinked acrylic fiber.

The crosslinked acrylic fiber thus obtained was immersed in an aqueous solution containing 0.1 mass % of silver nitrate that was previously adjusted to pH 1.5 with an aqueous nitric acid, subjected to an ion exchange reaction at 70° C. for 30 minutes, and then dehydrated, washed, and dried to give a fiber having silver ions, which was further treated in an alkali solution that was previously adjusted to pH 12.5 with an aqueous sodium hydroxide solution at 80° C. for 30 minutes.

A discoloration inhibitor (fiber 1), wherein 100 mole % of the carboxyl group was neutralized to sodium carboxylate group, having 1.0 mass % of silver base fine particles was obtained by this treatment. The content of metals in the discoloration inhibitor (fiber 1) is a value determined by an atomic absorption photometer after wet decomposition of the fiber in a mixed concentrate solution of nitric acid, sulfuric acid, and perchloric acid.

The fiber 1 was processed into a needle punched nonwoven fabric with a thickness of 177 g/m² (under an atmosphere of 20° C. and 65% RH). The potential of the nonwoven fabric as a discoloration inhibitor in a sulfur-containing gas atmosphere was determined, and the results are summarized in TABLE 1.

### COMPARATIVE EXAMPLE 1

A polyethylene terephthalate staple fiber having a filament fineness of 0.9 dtex and a length of 38 mm was processed into a needle punched nonwoven fabric having a thickness of 177 g/m² (under an environment at 20° C. and 65% RH). The potential of the nonwoven fabric as a discoloration inhibitor was determined in the same manner as above and the results are also summarized in TABLE 1.

TABLE 1

| | Reference | Discolouring | Atom Ratio (%) | | | | | | |
|---|---|---|---|---|---|---|---|---|---|
| | Sample | Gas | C | O | S | Ag | Cu | S/Ag | S/Cu |
| Example 1 | Ag | H₂S | 51.6 | 13.1 | 1.9 | 33.4 | — | 0.06 | — |
| | | SO₂ | 55.5 | 13.4 | 0.9 | 30.2 | — | 0.03 | — |
| | Cu | H₂S | 55.7 | 27.9 | 0.1 | — | 16.3 | — | 0.01 |
| | | SO₂ | 67.1 | 24.7 | 0.5 | — | 7.7 | — | 0.06 |
| Com. | Ag | H₂S | 46.4 | 15.7 | 5.2 | 32.7 | — | 0.16 | — |
| Example 1 | | SO₂ | 53.9 | 14.1 | 1.4 | 30.6 | — | 0.05 | — |
| | Cu | H₂S | 64.1 | 21.9 | 2.3 | — | 11.7 | — | 0.2 |
| | | SO₂ | 54 | 34.3 | 1.4 | — | 10.3 | — | 0.14 |

As is apparent from TABLE 1, the metal discoloration inhibitor (nonwoven fabric) of the present invention obtained in the EXAMPLE has the S atom ratio of the Ag and Cu reference samples smaller than those of the inhibitor obtained in the COMPARATIVE EXAMPLE 1. As a matter of fact, in the presence of the metal discoloration inhibitor obtained in EXAMPLE 1, there was observed almost no discoloration or staining of both Ag and Cu reference samples.

### INDUSTRIAL APPLICABILITY

As described above, the discoloration inhibitor of the present invention, comprising a fiber having a crosslinking structure and carboxylate groups therein for moisture absorption and retention, and fine particles of a metal and/or a metal compound having a potential to trap sulfur-containing compounds, is useful for trapping sulfur components present in the atmosphere of display or storage sites of metal artifacts.

This application is based on Japanese patent application No.2002-203792 filed on Jul. 12, 2002, whose priority is claimed under Paris convention, thus the contents thereof is incorporated by reference.

Consequently, presence of the discoloration inhibitor in the atmosphere of display or storage sites of metal artifacts, such as those made of silver, copper, and nickel, or the alloys thereof, enables efficient protection of the metal artifacts from the staining and discoloration by sulfur-containing gases, such as sulfur oxide (SOx), mercaptans, and hydrogen sulfide, and efficient protection of, for example, various ornaments, musical instruments, tableware made of noble metals from deterioration in quality during display and storage.

What is claimed is:

1. A discoloration inhibitor for metals, comprising: a fiber having a crosslinking structure and containing carboxyl groups bound thereto, at least part of said carboxyl groups being present as a salt of an alkali metal, an alkali earth metal or ammonia; and fine particles of a metal and/or a metal compound substantially insoluble in water and reactive with a sulfur-containing compound dispersed in said fiber.

2. The discoloration inhibitor according to claim 1 wherein 60 mole % or more of said carboxyl groups are neutralized with the salt of an alkali metal, an alkali earth metal or ammonia.

3. The discoloration inhibitor according to claim 1, wherein said metal and/or metal compound substantially insoluble in water is at least one metal or a compound of a metal selected from the group consisting of Ag, Cu, Zn, Mn, and Fe.

4. The discoloration inhibitor according to claim 1, wherein the content of said metal and/or metal compound substantially insoluble in water in said fiber is 0.1 mass % or more.

5. The discoloration inhibitor according to claim 1, wherein said fiber has a crosslinked acrylic fiber as the basic skeleton, at least part of the functional groups of said fiber molecule being hydrolyzed, and at least part of the hydrolyzed functional groups being present as a carboxylate salt.

6. The discoloration inhibitor according to claim 5 wherein 60 mole % or more of said carboxyl groups are neutralized with the salt of an alkali metal, an alkali earth metal or ammonia.

7. The discoloration inhibitor according to claim 1, wherein the discoloration inhibitor is in the shape of a wad of staple fiber or a nonwoven, woven, or knitted fabric.
